(19) United States
(12) Patent Application Publication
(10) Pub. No.: US 2018/0187078 A1
(43) Pub. Date: Jul. 5, 2018

(54) LIQUID CRYSTAL COMPOSITION AND LIQUID CRYSTAL DISPLAY DEVICE

(71) Applicant: Chunghwa Picture Tubes, LTD., Taoyuan City (TW)

(72) Inventors: Shin-Yi Cheng, New Taipei City (TW); Chien-Hua Chen, Hsinchu County (TW); Jan-Tian Lian, Keelung City (TW)

(73) Assignee: Chunghwa Picture Tubes, LTD., Taoyuan City (TW)

(21) Appl. No.: 15/489,651

(22) Filed: Apr. 17, 2017

(30) Foreign Application Priority Data
Dec. 29, 2016 (CN) 201611245302.0

(51) Int. Cl. C09K 19/38; G02F 1/1335; G02F 1/1368; C08F 222/02

(52) U.S. Cl. CPC C09K 19/3814; G02F 1/133514; G02F 1/133553; G02F 1/1368; G02F 2001/133616; C08F 222/02; G02F 2201/123; G02F 2201/50; G02F 1/1336

(57) ABSTRACT

A liquid crystal composition is provided. The liquid crystal composition includes a liquid crystal body, a first monomer, and an initiator. The first monomer is selected from one of a monomer shown in formula 1, a monomer shown in formula 2, and a monomer shown in formula 3; wherein the definitions of R₁, R₂, R₃, R₄, R₅, and R₆ are as provided in the specification. Based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %.

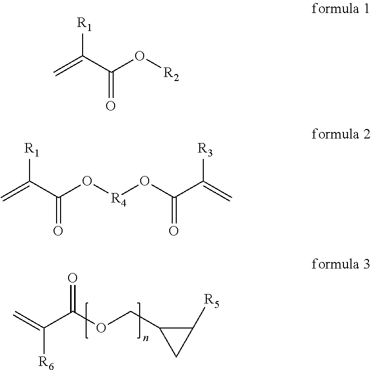

### CROSS-REFERENCE TO RELATED APPLICATION

This application claims the priority benefit of China application serial no. 201611245302.0, filed on Dec. 29, 2016. The entirety of the above-mentioned patent application is hereby incorporated by reference herein and made a part of this specification.

### BACKGROUND OF THE INVENTION

### Field of the Invention

The invention relates to a composition and a display device, and more particularly, to a liquid crystal composition and a liquid crystal display device.

### Description of Related Art

The liquid crystal display can generally be divided into the three major categories of transmissive, reflective, and transflective, wherein a reflective liquid crystal display utilizing both a front light source and external ambient light and a transflective liquid crystal display utilizing both a backlight source and external ambient light are suitable for application in a product such as a mobile device or a wearable device, and therefore are gradually receiving more attention. However, the current reflective liquid crystal display and transflective liquid crystal display both need a polarizing plate and an alignment film, and therefore the polarizing plate readily causes the reflectance and transmittance of the liquid crystal display to be reduced; and for the transflective liquid crystal display, the alignment angle readily causes the issue of mismatch between the reflection region and the transmittance region, such that grayscale is uncoordinated.

### SUMMARY OF THE INVENTION

The invention provides a liquid crystal composition that can form a liquid crystal layer suitable for application in a liquid crystal display device, such that the liquid crystal display device still has display function and good display performance without a polarizing plate and an alignment film.

The liquid crystal composition of the invention includes a liquid crystal body, a first monomer, and an initiator. The first monomer is selected from one of the monomer shown in formula 1, the monomer shown in formula 2, and the monomer shown in formula 3:

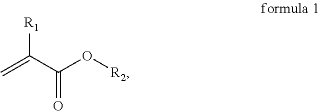

wherein R₁ is hydrogen or a methyl group, R₂ is hydrogen, a C₁ to C₂₀ alkyl group, a C₁ to C₁₀ alkoxy group, a C₃ to C₁₀ cycloalkyl group, an ester group, a C₆ to
C₂₀ aryl group, or a C₆ to C₂₀ heteroaryl group,

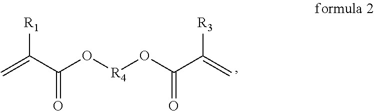

wherein R₃ is hydrogen or a methyl group, R₄ is a C₁ to C₂₀ alkylene group, an ether group, a polyether group, a C₃ to C₁₀ cycloalkylene group, or a C₆ to C₂₀ arylene group,

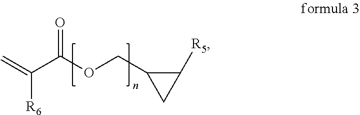

wherein R₅ represents a C₁ to C₂₀ alkyl group, a C₃ to C₁₀ cycloalkyl group, an ester group, a hydroxyl group, an ether group, a C₆ to C₂₀ aryl group, or a C₆ to C₂₀ heteroaryl group, and R₆ is hydrogen or a methyl group. Based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %.

The liquid crystal display device of the invention includes a liquid crystal display panel and a front light module. The liquid crystal display panel has a single cell gap, and the liquid crystal display panel includes an active element array substrate, a color filter substrate, and a liquid crystal layer. The active element array substrate includes a plurality of pixel units. Each of the plurality of pixel units includes an active element, a pixel electrode electrically connected to the active element, and a reflection pattern disposed on the pixel electrode, wherein the reflection pattern includes a metal layer and a transparent protective layer disposed on the metal layer, and the thickness of the metal layer is 1200 Å or more. The color filter substrate and the active element array substrate are disposed opposite to each other. The liquid crystal layer is disposed between the active element array substrate and the color filter substrate, and the liquid crystal layer is made by the liquid crystal composition above. The front light module is disposed on one side of the liquid crystal display panel adjacent to the color filter substrate.

The liquid crystal display device of the invention includes a liquid crystal display panel and a backlight module. The liquid crystal display panel has a single cell gap, and the liquid crystal display panel includes an active element array substrate, a color filter substrate, and a liquid crystal layer. The active element array substrate includes a plurality of pixel units. Each of the plurality of pixel units includes an active element, a pixel electrode electrically connected to the active element, and a reflection pattern disposed on the pixel electrode, wherein the reflection pattern includes a metal layer and a transparent protective layer disposed on the metal layer, and the thickness of the metal layer is between 50 Å and 600 Å. The color filter substrate and the active element array substrate are disposed opposite to each other. The liquid crystal layer is disposed between the active element array substrate and the color filter substrate, and the liquid crystal layer is made by the liquid crystal composition above. The backlight module is disposed on one side of the liquid crystal display panel adjacent to the active element array substrate.

Based on the above, the liquid crystal composition of the invention includes the liquid crystal body, the first monomer, and the initiator, wherein the first monomer is selected from one of the monomer shown in formula 1, the monomer shown in formula 2, and the monomer shown in formula 3, and based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %. As a result, the driving voltage of the resulting liquid crystal product is less than 5 V, and therefore the liquid crystal composition of the invention is suitable for the liquid crystal layer in the liquid crystal display device. Moreover, in the liquid crystal display device of the invention, since the liquid crystal layer is made by the liquid crystal composition of the invention and the reflection pattern including the metal layer having a thickness of 1200 Å or more is disposed on the pixel electrode, without a polarizing plate and an alignment film, not only does the liquid crystal display device still have display function, advantages of high reflectance, high optical uniformity, and high contrast can also be achieved, and therefore good display performance is achieved. More specifically, in the liquid crystal display device of the invention, since the liquid crystal layer is made by the liquid crystal composition of the invention and the reflection pattern including the metal layer having a thickness between 50 Å and 600 Å is disposed on the pixel electrode, without a polarizing plate and an alignment film, not only does the liquid crystal display device still have display function, advantages of high reflectance, high optical uniformity, high transmittance, and high contrast can also be achieved, and therefore good display performance is achieved.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a portion of a liquid crystal display device of an embodiment of the invention.

FIG. 2 is a cross-sectional schematic diagram of a portion of a liquid crystal display device of another embodiment of the invention.

FIG. 3 is a diagram of the relationship between driving voltage and transmittance of a test cell injected with the liquid crystal composition of Example 1 or Example 2.

### DESCRIPTION OF THE EMBODIMENTS

In the present specification, a range represented by “one numerical value to another numerical value” is a schematic representation for avoiding listing all of the numerical values in the range in the specification. Therefore, the recitation of a specific numerical range discloses any numerical value in the numerical range and a smaller numerical range defined by any numerical value in the numerical range, as is the case with the any numerical value and the smaller numerical range stated explicitly in the specification.

Moreover, in the present specification, skeleton formulas are sometimes used to represent compound structures. Such representation can omit carbon atoms, hydrogen atoms, and carbon-hydrogen bonds. Of course, structural formulas with clear illustrations of functional groups are definitive.

In the present specification, if it is not particularly specified whether a group is substituted, then the group can represent a substituted or unsubstituted group. For instance, “alkyl group” can represent substituted or unsubstituted alkyl group, and “aryl group” can represent substituted or unsubstituted aryl group.

Moreover, in the present specification, wherever possible, the same reference numerals are used in the drawings and descriptions to refer to the same or similar parts.

To develop a liquid crystal layer providing display function and good display performance to the liquid crystal display device without a polarizing plate and an alignment film, the invention provides a liquid crystal composition and a liquid crystal display device including a liquid crystal layer made by the liquid crystal composition that can achieve the above advantages. In the following, embodiments are provided to describe the liquid crystal composition and the liquid crystal display device of the invention in detail as examples of actual implementation of the invention, but the embodiments are not used to limit the invention.

An embodiment of the invention provides a liquid crystal composition including a liquid crystal body, a first monomer, and an initiator. Specifically, the liquid crystal composition of the present embodiment can form a liquid crystal layer suitable for a liquid crystal display device. Hereinafter, the various components above are described in detail.

In the present embodiment, the liquid crystal body is a nematic liquid crystal. Specifically, in the present embodiment, the composition of the liquid crystal body is not particularly limited, and any nematic liquid crystal known to those having ordinary skill in the art can be used for the liquid crystal body. Specifically, examples of commercial products of the liquid crystal body include (but are not limited to): TL213, MLC-2051, and MLC-2070 (made by Merck). Moreover, in the present embodiment, based on the total weight of the liquid crystal composition, the content of the liquid crystal body is 50 wt % to 90 wt %.

In the present embodiment, the first monomer is selected from one of the monomer shown in formula 1, the monomer shown in formula 2, and the monomer shown in formula 3:

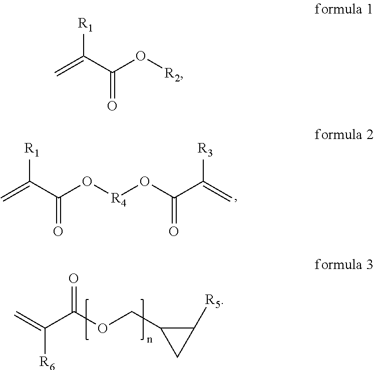

In formula 1, R₁ is hydrogen or a methyl group, R₂ is hydrogen, a C₁ to C₂₀ alkyl group, a C₁ to C₁₀ alkoxy group, a C₃ to C₁₀ cycloalkyl group, an ester group, a C₆ to C₂₀ aryl group, or a C₆ to C₂₀ heteroaryl group. Specifically, the monomer shown in formula 1 is a monofunctional acrylate monomer. Specifically, examples of the monomer shown in formula 1 include (but are not limited to): 3,5,5-trimethylhexyl acrylate (TMHA) or 2-phenoxyethyl acrylate.

In formula 2, R₃ is hydrogen or a methyl group, R₄ is a C₁ to C₂₀ alkylene group, an ether group, a polyether group, a C₃ to C₁₀ cycloalkylene group, or a C₆ to C₂₀ arylene group. Specifically, the monomer shown in formula 2 is a bifunctional acrylate monomer. Specifically, examples of the monomer shown in formula 2 include (but are not limited to): ethylene glycol dimethacrylate (EDMA).

In formula 3, R₅ represents a C₁ to C₂₀ alkyl group, a C₃ to C₁₀ cycloalkyl group, an ester group, a hydroxyl group, an ether group, a C₆ to C₂₀ aryl group, or a C₆ to C₂₀ heteroaryl group, and R₆ is hydrogen or a methyl group. Specifically, the monomer shown in formula 3 is an epoxy monomer. Specifically, examples of the monomer shown in formula 3 include (but not limited to): glycidyl methacrylate. In other words, in the present embodiment, the first monomer is a monofunctional acrylate monomer, a bifunctional acrylate monomer, or an epoxy monomer. From another perspective, in the present embodiment, the first monomer is a photopolymerizable monomer, i.e., a photopolymerization reaction occurs after UV irradiation. In the present embodiment, based on the total weight of the liquid crystal composition, the content of the first monomer is 2 wt % to 30 wt %. In the present embodiment, the viscous coefficient of the first monomer is 20 to 200.

In the present embodiment, the initiator is a photoinitiator facilitating the polymerization reaction. Specifically, in the present embodiment, the type of the initiator is not particularly limited, and any photoinitiator known to those having ordinary skill in the art can be used as the initiator. For instance, examples of the initiator include (but are not limited to): diphenyl (2,4,6-trimethylbenzoyl)-phosphine oxide (TPO), 2-benzyl-2-(dimethylamino)-1-[4-(4-morpholinyl)phenyl]-1-butanone (BDMPB), or 1-(1-hydroxy)cyclohexyl-1-phenyl ketone (HCPK). Moreover, in the present embodiment, the initiator can be implemented by a single initiator or implemented by two or more initiators. For instance, the initiator can be implemented by two photoinitiators having different reaction wavelengths. In the present embodiment, based on the total weight of the liquid crystal composition, the content of the initiator is 0.5 wt % to 3 wt %.

Moreover, in the present embodiment, the liquid crystal composition can further include a second monomer, oligomer, polymer, or a combination thereof in response to different properties of different liquid crystal bodies such as optical anisotropy and dielectric anisotropy. Hereinafter, the various components above are described in detail.

In the present embodiment, the liquid crystal composition can further include another monomer selected from the monomer shown in formula 1, the monomer shown in formula 2, and the monomer shown in formula 3 as a second monomer. In other words, in the present embodiment, the second monomer and the first monomer are different and are different types of monomers. For instance, in an embodiment, the first monomer is 2-phenoxyethyl acrylate and the second monomer is ethylene glycol dimethacrylate. That is, the first monomer is the monomer shown in formula 1 and the second monomer is the monomer shown in formula 2, or the first monomer is a monofunctional acrylate monomer and the second monomer is a bifunctional acrylate monomer. Moreover, in the present embodiment, the second monomer is also a photopolymerizable monomer. In the present embodiment, based on the total weight of the liquid crystal composition, the content of the second monomer is greater than 0 wt % but less than or equal to 10 wt %. In the present embodiment, the viscous coefficient of the second monomer is 20 to 200.

In the present embodiment, the liquid crystal composition can further include an oligomer selected from one of an oligomer of the monomer shown in formula 1, an oligomer of the monomer shown in formula 2, and an oligomer of the monomer shown in formula 3. In other words, the oligomer can be an oligomer obtained from the polymerization reaction of the monomer shown in formula 1, an oligomer obtained from the polymerization reaction of the monomer shown in formula 2, or an oligomer obtained from the polymerization reaction of the monomer shown in formula 3. Specifically, examples of the oligomer include (but are not limited to): polyethylene glycol diacrylate (PEG-DA) or neopentyl glycol diacrylate (NPGDA). In the present embodiment, based on the total weight of the liquid crystal composition, the content of the oligomer is greater than 0 wt % but less than or equal to 10 wt %. In the present embodiment, the viscous coefficient of the oligomer is 20 to 200.

In the present embodiment, the liquid crystal composition can further include a polymer selected from one of a polymer of the monomer shown in formula 1, a polymer of the monomer shown in formula 2, and a polymer of the monomer shown in formula 3. In other words, the polymer can be a polymer obtained from the polymerization reaction of the monomer shown in formula 1, a polymer obtained from the polymerization reaction of the monomer shown in formula 2, or a polymer obtained from the polymerization reaction of the monomer shown in formula 3. Specifically, examples of the polymer include (but are not limited to): poly(glycidyl methacrylate) (PGMA) and polyepoxy (meth)acrylate. Moreover, in the present embodiment, based on the total weight of the liquid crystal composition, the content of the polymer is greater than 0 wt % but less than or equal to 5 wt %. In the present embodiment, the viscous coefficient of the polymer is 20 to 200.

It should be mentioned that, in the present embodiment, the liquid crystal composition includes the liquid crystal body, the first monomer, and the initiator, wherein the first monomer is selected from one of the monomer shown in formula 1, the monomer shown in formula 2, and the monomer shown in formula 3, and based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %. As a result, the liquid crystal product obtained after the photopolymerization reaction of the liquid crystal composition from an irradiation process such as UV irradiation is suitable for application in the liquid crystal layer of the liquid crystal display device, and the reasons are as provided below.

By including the liquid crystal body, the first monomer, and the initiator in amounts of a specific range, wherein the first monomer is selected from one of the monomer shown in formula 1, the monomer shown in formula 2, and the monomer shown in formula 3, the driving voltage of the liquid crystal product obtained after the photopolymerization reaction of the liquid crystal composition is less than 5 V. In general, in the current products, the driving voltage of the active element array substrate of the liquid crystal display panel is less than about 5 V. As a result, the liquid crystal product made by the liquid crystal composition of the invention can meet the operating conditions of the current liquid crystal display panel and be suitable for a liquid crystal layer, and therefore the liquid crystal composition of the invention can be readily integrated into the current process and have good applicability and commercial value.

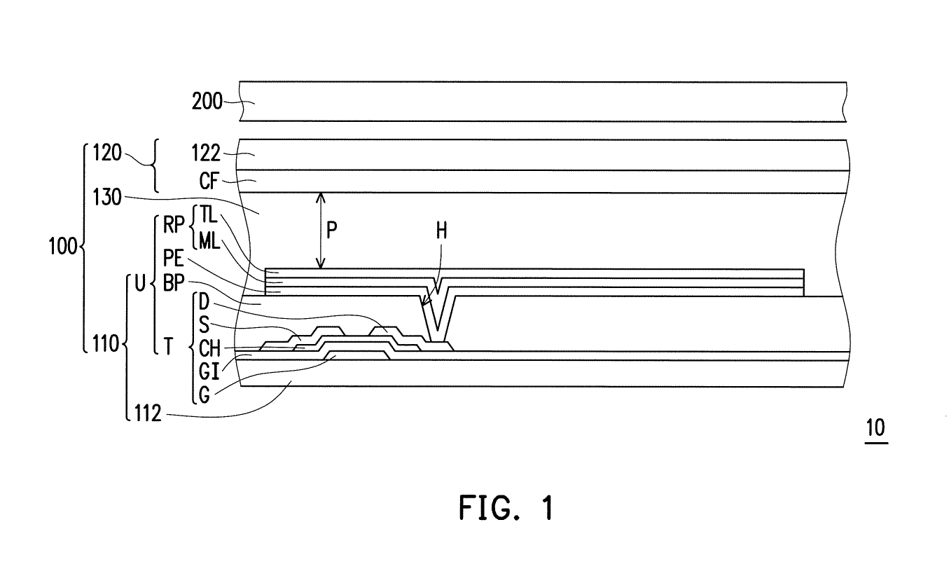

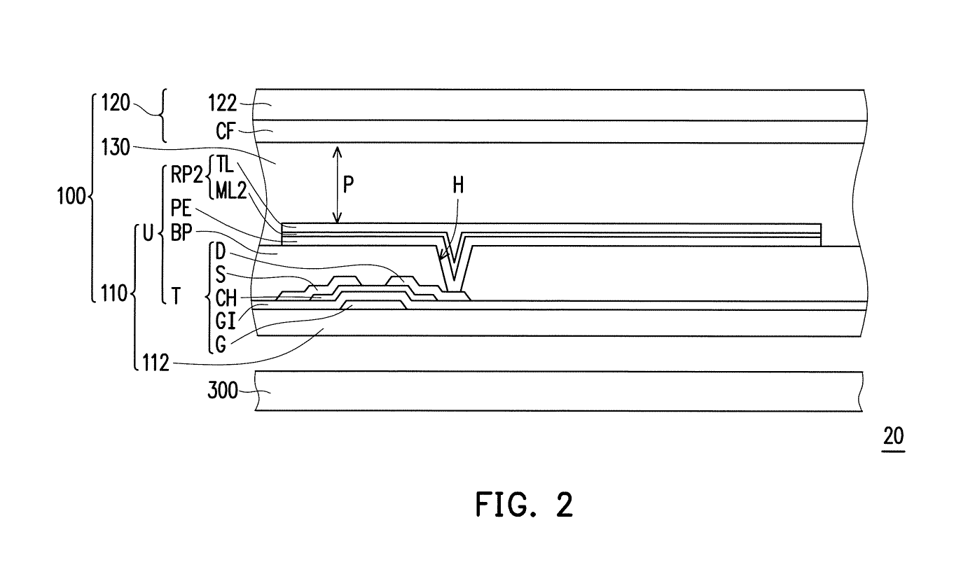

Hereinafter, the liquid crystal display device provided in the invention is described in detail according to FIG. 1 and FIG. 2.

FIG. 1 is a cross-sectional schematic diagram of a portion of a liquid crystal display device of an embodiment of the invention. Referring to FIG. 1, a liquid crystal display device 10 includes a liquid crystal display panel 100 and a front light module 200. In other words, in the present embodiment, the liquid crystal display device 10 is a reflective liquid crystal display device.

The liquid crystal display panel 100 includes an active element array substrate 110, a color filter substrate 120, and a liquid crystal layer 130. The active element array substrate 110 includes a substrate 112 and a plurality of pixel units U disposed on the substrate 112. Specifically, each of the pixel units U includes an active element T, a pixel electrode PE, and a reflection pattern RP. Moreover, in the present embodiment, each of the pixel units U further includes an insulating layer BP. For ease of explanation, in FIG. 1, only one pixel unit U is shown, but any person having ordinary skill in the art should be able to understand that, the plurality of pixel units U in the active element array substrate 110 is generally arranged in array.

The material of the substrate 112 can be (but not limited to): glass, quartz, organic polymer, opaque/reflective material (such as: conductive material, metal, wafer, ceramic, or other suitable materials), other suitable materials, or a stack or combination of at least two of the above.

The active element T can be a thin-film transistor including a gate G, a gate insulating layer GI, a channel layer CH, a drain D, and a source S. The gate G is disposed on the substrate 112. Out of consideration for conductivity, the material of the gate G is generally a metal material such as aluminum, gold, copper, molybdenum, chromium, or titanium. However, the invention is not limited thereto, and the material of the gate G can also be other conductive materials other than a metal material, such as: alloy, nitride of a metal material, oxide of a metal material, oxynitride of a metal material, or stacked layers of a metal material and other conductive materials. Moreover, in the present embodiment, the gate G is formed by one photomask process.

The gate insulating layer GI is conformally formed on the substrate 112 and covers the gate G. The material of the gate insulating layer GI can be (but not limited to), for instance: inorganic material, organic material, or a combination thereof, wherein the inorganic material is (but not limited to), for instance: silicon oxide, silicon nitride, silicon oxynitride, or stacked layers of at least two of the above; and the organic material is (but not limited to), for instance: a polymer material such as polyimide resin, epoxy resin, or acrylic resin.

The channel layer CH is disposed on the gate insulating layer GI above the gate G. The material of the channel layer CH includes (but is not limited to), for instance: amorphous silicon or oxide semiconductor material, wherein the oxide semiconductor material includes (but is not limited to), for instance: indium-gallium-zinc oxide (IGZO), zinc oxide, tin oxide (SnO), indium-zinc oxide, gallium-zinc oxide (GZO), zinc-tin oxide (ZTO), or indium-tin oxide. In other words, in the present embodiment, the active element T is, for instance, an amorphous silicon thin-film transistor or an oxide semiconductor thin-film transistor. However, the invention is not limited thereto. In other embodiments, the active element T can also be any thin-film transistor known to those having ordinary skill in the art such as a low-temperature polysilicon thin-film transistor, a silicon-based thin-film transistor, or a microcrystalline silicon thin-film transistor. Moreover, in the present embodiment, although the active element T is a bottom gate transistor, the invention is not limited thereto. In other embodiments, the active element T can also be a top gate transistor such as a top gate oxide semiconductor thin-film transistor. Moreover, in the present embodiment, the channel layer CH is formed by one photomask process.

The source S and the drain D are located above the channel layer CH. Out of consideration for conductivity, the material of the source S and the drain D is generally a metal material such as aluminum, gold, copper, molybdenum, chromium, or titanium. However, the invention is not limited thereto, and the material of the source S and the drain D can also be other conductive materials other than a metal material, such as: alloy, nitride of a metal material, oxide of a metal material, oxynitride of a metal material, or stacked layers of a metal material and other conductive materials. Moreover, in the present embodiment, the source S and the drain D are formed by one photomask process. It should be mentioned that, the gate G and the source S of the active element T respectively receive signals from the scan line and data line to drive the corresponding pixel unit U.

Moreover, in the present embodiment, the insulating layer BP further covers the active element T from above to protect the active element T or provide planarizing function. The insulating layer BP is conformally formed on the substrate 112, and the material of the insulating layer BP can be (but not limited to): inorganic material, organic material, or a combination thereof, wherein the inorganic material is (but not limited to), for instance: silicon oxide, silicon nitride, silicon oxynitride, or stacked layers of at least two of the above; and the organic material is (but not limited to), for instance: a polymer material such as polyimide resin, epoxy resin, or acrylic resin.

The pixel electrode PE is electrically connected to the active element T. Specifically, in the present embodiment, the pixel electrode PE is electrically connected to the drain D of the active element T via a contact opening H disposed in the insulating layer BP. In the present embodiment, the pixel electrode PE is, for instance, a transparent conductive layer, and the material thereof includes a metal oxide conductive material such as (but not limited to): indium-tin oxide (ITO), indium-zinc oxide, or aluminum-zinc oxide. Moreover, in the present embodiment, the pixel electrode PE is formed by one photomask process.

The reflection pattern RP is disposed on the pixel electrode PE. Specifically, in the present embodiment, the reflection pattern RP is a stacked structure including a metal layer ML and a transparent protective layer TL disposed on the metal layer ML. In the present embodiment, the material of the metal layer ML is not particularly limited, and can be any metal material known to those having ordinary skill in the art. Specifically, the material of the metal layer ML includes (but is not limited to): aluminum, silver, gild, or molybdenum. Moreover, in the present embodiment, the thickness of the metal layer ML is 1200 Å or more, and therefore the metal layer ML can achieve a near-total reflection effect such that the reflection pattern RP can have good reflection function and effectively reflect the light incident to the reflection pattern RP. Moreover, in the present embodiment, the transparent protective layer TL is, for instance, a transparent conductive layer, and the material thereof includes a metal oxide conductive material such as (but not limited to): indium-tin oxide (ITO), indium-zinc oxide, or aluminum-zinc oxide.

It should be mentioned that, in the present embodiment, the metal layer ML and the transparent protective layer TL are respectively formed by one photomask process, and in the photomask process of the metal layer ML and the transparent protective layer TL, the photomask used is the same as the photomask used to form the pixel electrode PE. As a result, in the present embodiment, the contour of the metal layer ML and the contour of the transparent protective layer TL are aligned or roughly aligned, and the contour of the reflection pattern RP and the contour of the pixel electrode PE are aligned or roughly aligned. It should be mentioned here that, in the present specification, aligned or roughly aligned contours means that a process resulting in inconsistent patterns for different layers is not deliberately performed, and therefore unaligned contours caused by process errors also count as aligned or roughly aligned contours.

More specifically, in the present embodiment, since the pixel electrode PE is formed on the flat surface of the insulating layer BP, and the pixel electrode PE, the metal layer ML, and the transparent protective layer TL are patterned using the same photomask, in comparison to a known reflective liquid crystal display device for which the pixel electrode is formed on the insulating layer having a bump at the top, the quantity of the photomask used in the manufacturing process of the liquid crystal display device 10 is less, and therefore the process is simpler, the manufacturing costs are reduced, and the process yield is increased.

The color filter substrate 120 and the active element array substrate 110 are disposed opposite to each other. Specifically, in the present embodiment, the color filter substrate 120 includes a substrate 122 and a plurality of color filter patterns CF disposed on the substrate 122. The material of the substrate 122 can be (but not limited to): glass, quartz, organic polymer, opaque/reflective material (such as: conductive material, metal, wafer, ceramic, or other suitable materials), other suitable materials, or a stack or combination of at least two of the above.

The color filter patterns CF are disposed corresponding to the pixel units U. As described above, for ease of illustration, only one pixel unit U is shown in FIG. 1, and therefore only one color filter pattern CF is shown in FIG. 1. Similarly, those having ordinary skill in the art should understand that, the plurality of color filter patterns CF in the color filter substrate 120 corresponding to the plurality of pixel units U is generally also arranged in several groups. Moreover, in the present embodiment, the color filter patterns CF are, for instance, red filter patterns, green filter patterns, blue filter patterns, white filter patterns, or filter patterns of other suitable colors decided by actual product requirement. Moreover, in the present embodiment, the color filter patterns CF can be implemented by any color filter pattern known to any person having ordinary skill in the art.

It should be mentioned that, the color filter substrate 120 of the present embodiment includes the color filter layers CF disposed on the substrate 122, but the invention is not limited thereto. In other embodiments, the color filter substrate 120 can be any color filter substrate known to any person having ordinary skill in the art. For instance, the color filter substrate 120 can further include a light-shielding pattern layer or an opposite electrode layer according to different design requirements.

Moreover, in the present embodiment, the same gap P exists between the color filter substrate 120 and the reflection patterns RP. In other words, in the present embodiment, the liquid crystal display panel 100 has a single cell gap.

The liquid crystal layer 130 is disposed between the active element array substrate 110 and the color filter substrate 120. Specifically, in the present embodiment, the liquid crystal layer 130 is made by any of the liquid crystal compositions in the embodiments above. Relevant descriptions of the liquid crystal composition are as provided in detail in the above embodiments, and are therefore not repeated herein. Moreover, in the present embodiment, the manufacturing method of the liquid crystal layer 130 is not particularly limited, and the liquid crystal layer 130 can also be made using any method known to those having ordinary skill in the art. For instance, the manufacturing method of the liquid crystal layer 130 includes: injecting the liquid crystal composition of any of the above embodiments between the active element array substrate 110 and the color filter substrate 120 and then irradiating the liquid crystal composition with UV, wherein the injection method includes a drop-fill method or a vacuum injection method. Moreover, in the present embodiment, the liquid crystal layer 130 is in direct contact with the reflection pattern RP. In the present embodiment, the liquid crystal layer 130 is in direct contact with the color filter substrate 120.

The front light module 200 is disposed on one side of the liquid crystal display panel 100 adjacent to the color filter substrate 120. In other words, the front light module 200 is disposed on one side of the displaying surface of the liquid crystal display panel 100. In the present embodiment, the structure of the front light module 200 is not particularly limited, and any front light module known to those having ordinary skill in the art can be used to implement the front light module 200.

It should be mentioned that, in the present embodiment, since the liquid crystal layer 130 is made by the liquid crystal composition in any one of the above embodiments, the liquid crystal display device 10 can display an image frame without a polarizing plate and an alignment film. More specifically, in the present embodiment, since the liquid crystal layer 130 is made by the liquid crystal composition in any one of the above embodiments and the reflection pattern RP including the metal layer ML having a thickness of 1200 Å or more is disposed on the pixel electrode PE, without a polarizing plate and an alignment film, not only does the liquid crystal display device 10 still have display function, advantages of high reflectance, high optical uniformity, and high contrast can also be achieved, and therefore good display performance is achieved. Specifically, in the present embodiment, the reflectance of the liquid crystal display device 10 reaches 20% or more.

Due to the advantages of high reflectance and high optical uniformity of the liquid crystal display device 10, good display performance and visibility can be achieved in sufficient ambient light source without turning on the front light module 200, such that the liquid crystal display device 10 has the characteristic of power saving. Due to the advantages of high reflectance and high optical uniformity of the liquid crystal display device 10, good display performance and visibility can still be achieved in insufficient intensity of ambient light source by adjusting the light intensity of the front light module 200. Moreover, since the liquid crystal display device 10 does not contain a polarizing plate and has the advantages of high reflectance and high optical uniformity, the liquid crystal display device 10 can achieve good display performance and visibility in a weaker light intensity from the front light module 200 in comparison to a known reflective liquid crystal display device when light source compensation is to be performed using the front light module 200, such that the liquid crystal display device 10 has the characteristic of power saving. Moreover, in the present embodiment, the liquid crystal display device 10 can further include an ambient light sensing component for sensing the intensity of ambient light source and suitably adjusting the light intensity of the front light module 200. The ambient light sensing component can be any ambient light sensing component known to those having ordinary skill in the art, and the ambient light sensing component is, for instance, disposed on the edge of the assembly housing.

Moreover, although the liquid crystal display device 10 is a reflective liquid crystal display device, the liquid crystal product made by any liquid crystal composition in the above embodiments can also be applied in a transflective liquid crystal display device. Hereinafter, the transflective liquid crystal display device provided in the invention is described according to FIG. 2. It should be mentioned here that, the following embodiment of FIG. 2 adopts the reference numerals of the embodiment of FIG. 1 and a portion of the content thereof, wherein the same or similar reference numerals are used to represent the same or similar components and descriptions of the same technical content are omitted. Descriptions of the omitted portions are as provided above and are not repeated herein.

FIG. 2 is a cross-sectional schematic diagram of a portion of a liquid crystal display device of another embodiment of the invention. Referring to both FIG. 2 and FIG. 1 the differences between the two are described below.

In the present embodiment, a liquid crystal display device 20 includes a backlight module 300 disposed on one side of the liquid crystal display panel 100 adjacent to the active element array substrate 110. In other words, the backlight module 300 is disposed on one side of the back of the liquid crystal display panel 100. In the present embodiment, the structure of the backlight module 300 is not particularly limited, and any backlight module known to those having ordinary skill in the art can be used to implement the backlight module 300.

In the present embodiment, the thickness of a metal layer ML2 in a reflection pattern RP2 is between 50 Å and 600 Å, and therefore the metal layer ML2 can achieve the effect of transflectance. Therefore, the reflection pattern RP can reflect light incident to the reflection pattern RP or the reflection pattern RP can let light from the back light module 300 pass through.

It should be mentioned that, in the present embodiment, similarly, since the liquid crystal layer 130 is made by the liquid crystal composition in any one of the above embodiments, the liquid crystal display device 20 can display an image frame without a polarizing plate and an alignment film. More specifically, in the present embodiment, since the liquid crystal layer 130 is made by the liquid crystal composition in any one of the above embodiments and the reflection pattern RP2 including the metal layer ML2 having a thickness between 50 Å and 600 Å is disposed on the pixel electrode PE, not only does the liquid crystal display device 20 still have display function without a polarizing plate and an alignment film, advantages of high reflectance, high optical uniformity, high transmittance, and high contrast can also be achieved in comparison to a known transflectance liquid crystal display device having a reflection region and a transmittance region, and therefore good display performance is achieved. Specifically, in the present embodiment, the liquid crystal display device 20 has a reflectance reaching 5% to 60% and a transmittance reaching 1% to 60%.

As described above, since the metal layer ML2 provides the effect of transflectance and the metal layer ML2 and the transparent protective layer TL are both formed on the pixel electrode PE using the same photomask used to form the pixel electrode PE, in comparison to a known transflective liquid crystal display device having a reflection region and a transmittance region, the photomask used in the manufacturing process of the liquid crystal display device 20 of the invention is simpler and in lesser quantity, and therefore the manufacturing process is simpler, the manufacturing cost is reduced, and the process yield is increased. Moreover, by disposing the reflection pattern RP2 on the pixel electrode PE, the liquid crystal display device 20 has a comprehensive transflectance effect, such that the liquid crystal display device 20 has the advantages of high reflectance, high optical uniformity, and high transmittance in comparison to a known transflectance liquid crystal display device having a reflection region and a transmittance region.

More specifically, due to the advantages of high reflectance and high optical uniformity of the liquid crystal display device 20, good display performance and visibility can be achieved in sufficient ambient light source without turning on the backlight module 300, such that the liquid crystal display device 20 has the characteristic of power saving. Due to the advantages of high reflectance, high optical uniformity, and high transmittance of the liquid crystal display device 20, good display performance and visibility can still be achieved in insufficient ambient light source intensity by adjusting the light intensity of the backlight module 300. Moreover, since the liquid crystal display device 20 does not contain a polarizing plate and has the advantages of high reflectance, high optical uniformity, and high transmittance, the liquid crystal display device 20 can achieve good display performance and visibility in a weaker light intensity from the backlight module 300 in comparison to a known transflective liquid crystal display device when light source compensation is to be performed using the backlight module 300, such that the liquid crystal display device 20 has the characteristic of power saving. Moreover, in the present embodiment, the liquid crystal display device 20 can further include an ambient light sensing component for sensing the intensity of ambient light source and suitably adjusting the light intensity of the backlight module 300. The ambient light sensing component can be any ambient light sensing component known to those having ordinary skill in the art, and the ambient light sensing component is, for instance, disposed on the edge of the assembly housing.

The features of the invention are more specifically described in the following with reference to Examples 1 to 2. Although the following Examples 1 to 2 are described, the materials used and the amounts and ratios thereof, as well as handling details and handling processes . . . etc., can be suitably modified without exceeding the scope of the invention. Accordingly, restrictive interpretation should not be made to the invention based on the examples described below.

The main materials used in the preparation of the liquid crystal compositions of Examples 1 to 2 are as shown below.

Liquid Crystal Body:

model: TL213, made by Merck;

model: MLC-2070, made by Merck.

First Monomer and Second Monomer:

3,5,5-trimethylhexyl acrylate (hereinafter TMHA): purchased from Eternal Chemical Co., Ltd.;

2-phenoxyethyl acrylate: purchased from Eternal Chemical Co., Ltd.;

ethylene glycol dimethacrylate (hereinafter EDMA): purchased from Eternal Chemical Co., Ltd.

Oligomer:

polyethylene glycol diacrylate (hereinafter PEG-DA): purchased from Eternal Chemical Co., Ltd., molecular weight: 800.

Polymer:

poly(glycidyl methacrylate) (hereinafter PGMA): purchased from Eternal Chemical Co., Ltd.;

polyepoxyacrylate: purchased from Eternal Chemical Co., Ltd.

Initiator:

diphenyl (2,4,6-trimethylbenzoyl)-phosphine oxide (hereinafter TPO): purchased from Eternal Chemical Co., Ltd.;

2-benzyl-2-(dimethylamino)-1-[4-(4-morpholinyl)phenyl]-1-butanone (hereinafter BDMPB): purchased from Eternal Chemical Co., Ltd.

### Preparation Example 1 of Liquid Crystal Composition

### Example 1

The liquid crystal body, first monomer, oligomer, polymer, and initiator were mixed according to the proportions and types shown in Table 1 to prepare the liquid crystal composition of Example 1.

### Example 2

The liquid crystal body, first monomer, second monomer, polymer, and initiator were mixed according to the proportions and types shown in Table 1 to prepare the liquid crystal composition of Example 2.

TABLE 1

| wt % | | Example 1 | Example 2 |
|---|---|---|---|
| Liquid crystal | TL213 | 55 | — |
| body | MLC-2070 | — | 85 |
| First monomer | TMHA | 25 | — |
| | 2-phenoxyethyl acrylate | — | 6.5 |
| | EDMA | — | — |
| Second monomer | TMHA | — | — |
| | 2-phenoxyethyl acrylate | — | — |
| | EDMA | — | 3.5 |
| Oligomer | PEG-DA | 5 | — |
| Polymer | PGMA | 2.5 | — |
| | Polyepoxyacrylate | — | 2.5 |
| Initiator | BDMPB | 0.5 | — |
| | TPO | 2 | 2.5 |

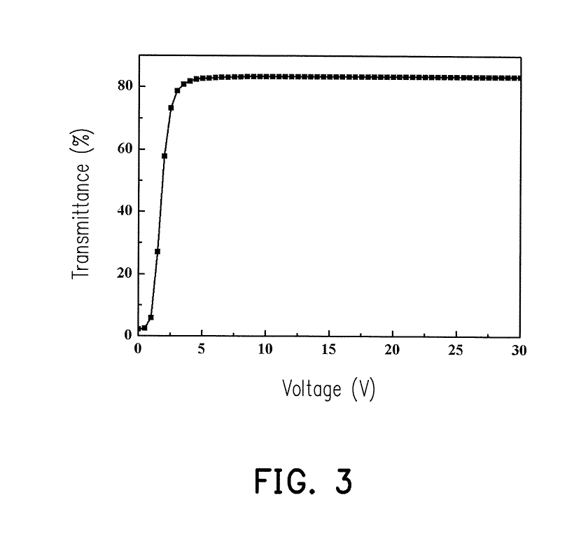

Next, measurement of the relationship between driving voltage and transmittance was performed on the liquid crystal compositions of Examples 1 to 2, and the measurement results thereof are as shown in FIG. 3.

FIG. 3 is a diagram of the relationship between driving voltage and transmittance of a test cell injected with the liquid crystal composition of Example 1 or Example 2. The measuring steps include: providing a test cell including two substrates each having a conductive film disposed opposite to each other; injecting the liquid crystal composition of Example 1 or Example 2 between the two substrates via an ODF or vacuum injection process; performing an irradiation process to irradiate UV light on the test cell, wherein in Example 1, the irradiation wavelengths are respectively 325 nm and 365 nm; and in Example 2, the irradiation wavelength is 365 nm.

It can be known from FIG. 3 that, the driving voltage of each of the liquid crystal products made by the liquid crystal compositions of Examples 1 to 2 is about 3.5 V. These results prove that, the liquid crystal composition of the invention includes the liquid crystal body, the first monomer, and the initiator, wherein the first monomer is selected from one of the monomer shown in formula 1, the monomer shown in formula 2, and the monomer shown in formula 3, and based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %, and thereby the driving voltage of the resulting liquid crystal product is less than 5 V. As a result, the liquid crystal product made by the liquid crystal composition of the invention can meet the operating conditions of the current liquid crystal display panel and be suitable for a liquid crystal layer.

Based on the above, the liquid crystal composition of the invention includes the liquid crystal body, the first monomer, and the initiator, wherein the first monomer is selected from one of the monomer shown in formula 1, the monomer shown in formula 2, and the monomer shown in formula 3, and based on the total weight of the liquid crystal composition, the content of the liquid crystal body is 50 wt % to 90 wt %, the content of the first monomer is 2 wt % to 30 wt %, and the content of the initiator is 0.5 wt % to 3 wt %. As a result, the driving voltage of the resulting liquid crystal product is less than 5 V, and therefore the liquid crystal composition of the invention is suitable for the liquid crystal layer in the liquid crystal display device. Moreover, in the liquid crystal display device of the invention, since the liquid crystal layer is made by the liquid crystal composition of the invention and the reflection pattern including the metal layer having a thickness of 1200 Å or more is disposed on the pixel electrode, without a polarizing plate and an alignment film, not only does the liquid crystal display device still have display function, advantages of high reflectance, high optical uniformity, and high contrast can also be achieved, and therefore good display performance is achieved. More specifically, in the liquid crystal display device of the invention, since the liquid crystal layer is made by the liquid crystal composition of the invention and the reflection pattern including the metal layer having a thickness between 50 Å and 600 Å is disposed on the pixel electrode, without a polarizing plate and an alignment film, not only does the liquid crystal display device still have display function, advantages of high reflectance, high optical uniformity, high transmittance, and high contrast can also be achieved, and therefore good display performance is achieved.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A liquid crystal composition, comprising:
a liquid crystal body;
a first monomer selected from one of a monomer shown in formula 1, a monomer shown in formula 2, and a monomer shown in formula 3: 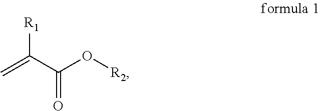
wherein R₁ is hydrogen or a methyl group, R₂ is hydrogen, a C₁ to C₂₀ alkyl group, a C₁ to C₁₀ alkoxy group, a C₃ to C₁₀ cycloalkyl group, an ester group, a C₆ to C₂₀ aryl group, or a C₆ to C₂₀ heteroaryl group, 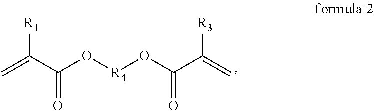
wherein R₃ is hydrogen or a methyl group, R₄ is a C₁ to C₂₀ alkylene group, an ether group, a polyether group, a C₃ to C₁₀ cycloalkylene group or a C₆ to C₂₀ arylene group, 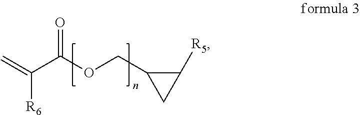
wherein R₅ represents a C₁, to C₂₀ alkyl group, a C₃ to C₁₀ cycloalkyl group, an ester group, a hydroxyl group, an ether group, a C₆ to C₂₀ aryl group, or a C₆ to C₂₀ heteroaryl group, and R₆ is hydrogen or a methyl group; and
an initiator, wherein based on a total weight of the liquid crystal composition, a content of the liquid crystal body is 50 wt % to 90 wt %, a content of the first monomer is 2 wt % to 30 wt %, and a content of the initiator is 0.5 wt % to 3 wt %.

2. The liquid crystal composition of claim 1, further comprising a second monomer selected from another one of the monomer shown in formula 1, the monomer shown n formula 2, and the monomer shown in formula 3.

3. The liquid crystal composition of claim 2, wherein based on the total weight of the liquid crystal composition, a content of the second monomer is greater than 0 wt % but less than or equal to 10 wt %.

4. The liquid crystal composition of claim 1, further comprising an oligomer selected from one of an oligomer of the monomer shown in formula 1, an oligomer of the monomer shown in formula 2, and an oligomer of the monomer shown in formula 3.

5. The liquid crystal composition of claim 4, wherein based on the total weight of the liquid crystal composition, a content of the oligomer is greater than 0 wt % but less than or equal to 10 wt %.

6. The liquid crystal composition of claim 1, further comprising a polymer selected from one of a polymer of the monomer shown in formula 1, a polymer of the monomer shown in formula 2, and a polymer of the monomer shown in formula 3.

7. The liquid crystal composition of claim 6, wherein based on a total weight of the liquid crystal composition, a content of the polymer is greater than 0 wt % but less than or equal to 5 wt %.

8. The liquid crystal composition of claim 1, wherein the liquid crystal body is a nematic liquid crystal.

9. A liquid crystal display device, comprising:
a liquid crystal display panel having a single cell gap, wherein the liquid crystal display panel comprises:
an active element array substrate comprising a plurality of pixel units, wherein each of the plurality of pixel units comprises:
an active element;
a pixel electrode electrically connected to the active element; and
a reflection pattern disposed on the pixel electrode, wherein the reflection pattern comprises a metal layer and a transparent protective layer disposed on the metal layer, and a thickness of the metal layer is 1200 Å or more;
a color filter substrate disposed opposite to the active element array substrate; and
a liquid crystal layer disposed between the active element array substrate and the color filter substrate, wherein the liquid crystal layer is made by the liquid crystal composition of claim 1; and
a front light module disposed on one side of the liquid crystal display panel adjacent to the color filter substrate.

10. The liquid crystal display device of claim 9, wherein a material of the pixel electrode comprises indium-tin oxide, indium-zinc oxide, or aluminum-zinc oxide.

11. The liquid crystal display device of claim 9, wherein a material of the metal layer comprises aluminum, silver, gold, or molybdenum.

12. The liquid crystal display device of claim 9, wherein a material of the transparent protective layer comprises indium-tin oxide, indium-zinc oxide, or aluminum-zinc oxide.

13. The liquid crystal display device of claim 9, wherein the liquid crystal layer is in direct contact with the plurality of reflection patterns of the plurality of pixel units.

14. The liquid crystal display device of claim 9, wherein a driving voltage of the liquid crystal layer is less than 5 V.

15. A liquid crystal display device, comprising:
a liquid crystal display panel having a single cell gap, wherein the liquid crystal display panel comprises:
an active element array substrate comprising a plurality of pixel units, wherein each of the plurality of pixel units comprises:
an active element;
a pixel electrode electrically connected to the active element; and
a reflection pattern disposed on the pixel electrode, wherein the reflection pattern comprises a metal layer and a transparent protective layer disposed on the metal layer, and a thickness of the metal layer is between 50 Å and 600 Å;
a color filter substrate disposed opposite to the active element array substrate; and
a liquid crystal layer disposed between the active element array substrate and the color filter substrate, wherein the liquid crystal layer is made by the liquid crystal composition of claim 1; and
a backlight module disposed on one side of the liquid crystal display panel adjacent to the active element array substrate.

16. The liquid crystal display device of claim 15, wherein a material of the pixel electrode comprises indium-tin oxide, indium-zinc oxide, or aluminum-zinc oxide.

17. The liquid crystal display device of claim 15, wherein a material of the metal layer comprises aluminum, silver, gold, or molybdenum.

18. The liquid crystal display device of claim 15, wherein a material of the transparent protective layer comprises indium-tin oxide, indium-zinc oxide, or aluminum-zinc oxide.

19. The liquid crystal display device of claim 15, wherein the liquid crystal layer is in direct contact with the plurality of reflection patterns of the plurality of pixel units.

20. The liquid crystal display device of claim 15, wherein a driving voltage of the liquid crystal layer is less than 5 V.
